(19) United States
(12) Patent Application Publication
(10) Pub. No.: US 2003/0226377 A1
(43) Pub. Date: Dec. 11, 2003

(54) Method of making silica-titania extreme ultraviolet elements

(76) Inventors: W. Tim Barrett, Odessa, NY (US); Bradley F. Bowden, Edison, NJ (US); Claude L. Davis, Painted Post, NY (US); Kenneth E. Hrdina, Horseheads, NY (US); Michael MR. Robinson, Hammondsport, NY (US); Michael H. Wasilewski, Corning, NY (US); John F. Wight, Corning, NY (US)

Correspondence Address: CORNING INCORPORATED, SP-TI-3-1, CORNING, NY, 14831

(21) Appl. No.: 10/378,390

(22) Filed: Mar. 3, 2003

Related U.S. Application Data
(60) Provisional application No. 60/362,053, filed on Mar. 5, 2002.

(51) Int. Cl. C03B 19/00

(52) U.S. Cl. 65/17.4; 65/17.6

(57) ABSTRACT

Methods and apparatus for manufacturing titania-containing fused silica bodies are disclosed. The titania-containing fused silica bodies are subsequently processed to make extreme ultraviolet soft x-ray masks. The methods and apparatus involve providing powders external to a furnace cavity and depositing the powders in the furnace cavity to form a titania-containing fused silica body.

### FIELD OF THE INVENTION

This invention relates to ultra low expansion extreme ultraviolet elements made from glasses including silica and titania. More particularly, the invention relates to methods and apparatus used for making such elements.

### BACKGROUND OF THE INVENTION

Ultra low expansion glasses and soft x-ray or extreme ultraviolet (EUV) lithographic elements made from silica and titania traditionally have been made by flame hydrolysis of organometallic precursors of silica and titania. As shown in FIG. 1, a conventional apparatus for the manufacture of titania-containing silica glasses includes high purity silicon-containing feedstock or precursor 14 and high purity titanium-containing feedstock or precursor 26. The feedstock or precursor materials are typically siloxanes, alkoxides and tetrachlorides containing titanium or silicon. One particular commonly used silicon-containing feedstock material is octamethylcyclotetrasiloxane, and one particular commonly used titanium-containing feedstock material is titanium isopropoxide. An inert bubbler gas 20 such as nitrogen is bubbled through feedstocks 14 and 26, to produce mixtures containing the feedstock vapors and carrier gas. An inert carrier gas 22 such as nitrogen is combined with the silicon feedstock vapor and bubbler gas mixture and with the titanium feedstock vapor and bubbler gas mixture to prevent saturation and to deliver the feedstock materials 14, 26 to the conversion site 10 through distribution systems 24 and manifold 28. The silicon feedstock and vapor and titanium feedstock and vapor are mixed in the manifold 28 to form a homogeneous, vaporous, titania-containing silica glass precursor mixture which is delivered through conduits 34 to conversion site burners 36 mounted in the upper portion 38 of the furnace 16. The burners 36 produce burner flames 37. Conversion site burner flames 37 are formed with a fuel and oxygen mixture such as methane mixed with hydrogen and/or oxygen, which combusts, oxidizes and converts the feedstocks at temperatures greater than about 1600° C. into soot 11. The burner flames 37 also provide heat to consolidate the soot 11 into glass. The temperature of the conduits 34 and the feedstocks contained in the conduits are typically controlled and monitored in minimize the possibility of reactions prior to the flames 37.

The feedstocks are delivered to a conversion site 10, where they are converted into titania-containing silica soot particles 11. The soot 11 is deposited in a revolving collection cup 12 located in a refractory furnace 16 typically made from zircon and onto the upper glass surface of a hot titania-silica glass body 18 inside the furnace 16. The soot particles 11 consolidate into a titania-containing high purity silica glass body.

The cup typically has a circular diameter shape of between about 0.2 meters and 2 meters so that the glass body 18 is a cylindrical body having a diameter D between about 0.2 and 2 meters and a height H between about 2 cm and 20 cm. The weight percent of titania in the fused silica glass can be adjusted by changing the amount of either the titanium feedstock or silicon-containing feedstock delivered to the conversion site 10 that is incorporated into the soot 11 and the glass 18. The amount of titania is adjusted so that the glass body has a coefficient of thermal expansion of about zero at the operating temperature of an EUV or soft x-ray reflective lithography or mirror element.

Ultra-low expansion silica-titania articles of glass made by the above-described method are used in the manufacture of elements used in mirrors for telescopes used in space exploration and extreme ultraviolet or soft x-ray-based lithography. These lithography elements are used with extreme ultraviolet or soft x-ray radiation to illuminate, project and reduce pattern images that are utilized to form integrated circuit patterns. The use of extreme ultraviolet or soft x-ray radiation is beneficial in that smaller integrated circuit features can be achieved, however, the manipulation and direction of radiation in this wavelength range is difficult. Accordingly, use of wavelengths in the extreme ultraviolet or soft x-ray range, such as in the 1 nm to 70 nm range, has not been widely used in commercial applications. One of the limitations in this area has been the inability to economically manufacture mirror elements that can withstand exposure to such radiation while maintaining a stable and high quality circuit pattern image. Thus, there is a need for stable high quality glass lithographic elements for use with extreme soft x-ray radiation.

One limitation of ultra low expansion titania-silica glass made in accordance with the method described above is that the glass contains striae. Striae are optical inhomogeneities which adversely effects transmission in lens and window elements made from the glass. In some cases, striae have been found to impact surface finish at an angstrom root mean rms level in reflective optic elements made from the glass. Extreme ultraviolet lithographic elements require finishes having a very low rms level.

It would be advantageous to provide new methods and apparatus for manufacturing ultra low expansion glasses containing silica and titania. In particular, it would be desirable to provide methods and apparatus that are capable of producing such glass with decreased inhomogeneities in the body of the glass.

### SUMMARY OF THE INVENTION

The invention relates to methods and apparatus for producing titania-silica ultra low expansion glass bodies which are used as preforms for extreme ultraviolet optical or lithographic elements. Methods and apparatus are provided can producing ultra low expansion glass bodies and extreme ultraviolet optical or lithographic elements having decreased inhomogeneities. As used herein, the terms extreme ultraviolet (abbreviated as EUV) and soft x-ray will be used interchangeably to refer to short wavelengths of electromagnetic radiation between 1 nm and 70 nm. Presently, lithographic systems that utilize EUV radiation operate between 5 and 15 nm, and typically around 13 nm.

According to one embodiment of the invention, a method of making a body of high purity fused silica glass containing titania and extreme ultraviolet lithographic elements made therefrom includes the steps of providing a furnace cavity heated to a temperature sufficient to consolidate titania-containing silica powder into a glass and providing titania-containing silica powder outside of the furnace cavity. The method also includes the steps of delivering the titania-containing silica powder to the interior of the furnace cavity and consolidating the titania-containing silica powder into a glass body. After formation of the glass body, it can be finished into an optical element by using conventional steps such as cutting, polishing, cleaning, generating a curved surface and coating the element with an appropriate reflective coating. In certain embodiments, the titania concentration in the silica powder is between 3 weight percent and 10 weight percent, and in other embodiments, the furnace is heated to a temperature above 1600° C.

In some embodiments, the powder is delivered at a rate to prevent trapping of gases by overlapping powder layers. In certain embodiments, the titania-silica powder is pre-mixed on an atomic scale prior to delivery into the furnace. According to some embodiments, the powder is provided by flame hydrolysis of silicon-containing and titanium-containing precursors. In other embodiments, the powder is provided by sol-gel processing. In still other embodiments, the powder is provided by grinding titania-silica glass cullet.

It may be desirable to spray dry or agglomerate the powder prior to delivery of the powder into the furnace. Agglomeration methods that can be used include the use of a pan pelletizer or by mixing powders into a liquid to form and slurry and drying droplets of the slurry into agglomerates. In certain embodiments, it may be useful to preconsolidate the powder particles prior to delivery into the furnace. In the embodiments in which a preconsolidation step is utilized, the preconsolidation step is performed preferably at a temperature above 1300° C. In certain embodiments, the preconsolidation step is performed in a helium or vacuum atmosphere. According to some embodiments, it may be desirable to hot isostatically press the glass body at a temperature exceeding 1200° C. and a pressure exceeding 50 pounds per square inch.

In another embodiment of the invention, a method of manufacturing a reflective extreme ultraviolet or soft x-ray lithography element is provided that includes the steps of providing a furnace cavity heated to a temperature sufficient to consolidate titania-containing silica powder into a glass and providing titania-containing silica powder outside of the furnace cavity. The titania-containing silica powder is delivered to the interior of the furnace cavity where it is consolidated into a glass body or lithography element preform, and the glass body or lithography element preform is then finished into a lithography element surface. Certain embodiments may include the step of pre-consolidating the powder particles in a helium or vacuum environment prior to delivery into the furnace at a temperature above 1300° C. In some embodiments, the powder is delivered into the furnace cavity at a constant rate.

Another embodiment of the invention pertains to an apparatus for manufacturing a body of high purity fused silica glass containing titania. The apparatus comprises a furnace including a cavity heated to a temperature sufficient to consolidate titania-containing silica powder into a glass body, a supply of titania-containing silica powder located outside of the furnace cavity and a delivery system for transporting the titania-containing silica powder to the interior of the furnace cavity.

In some embodiments of the apparatus, the supply of powder includes a flame hydrolysis system for converting silicon-containing precursors and titanium-containing precursors into titania-containing silica. In other embodiments of the apparatus, the supply of powder includes a sol-gel powder manufacturing system. In still other embodiments, the supply of powder includes ground glass cullet.

Some embodiments of the apparatus include a hot isostatic press. In certain apparatus embodiments, the powder feed system includes an auger connected to a conduit disposed above the furnace cavity. In alternative embodiments, the powder feed system includes a conduit connected to an air movement system. In these embodiments, the air movement system may include a blower. In another embodiment, the powder feed system includes a vibrating gravity feed system. In some embodiments, the powder feed system further includes a powder distribution system located proximate the furnace cavity. In other embodiments, the powder distribution system includes a nozzle.

According to the present invention, methods and apparatus are provided for the production of improved ultra low expansion titania-containing fused silica glass and extreme ultraviolet lithographic elements made therefrom. The methods and apparatus of the present invention enable the production ultra low expansion glass having decreased inhomogeneities in the body of the glass.

Additional advantages of the invention will be set forth in the following detailed description. It is to be understood that both the foregoing general description and the following detailed description are exemplary and are intended to provide further explanation of the invention as claimed.

### BRIEF DESCRIPTION OF THE DRAWINGS

FIG. 1 is a schematic drawing of a prior art apparatus for manufacturing ultra low expansion glass;

FIG. 2 is a schematic drawing of an apparatus for manufacturing ultra low expansion glass according to one embodiment of the invention;

FIG. 3 is a schematic drawing of an apparatus for manufacturing ultra low expansion glass according to another embodiment of the invention;

FIG. 4 is a schematic drawing of an apparatus for manufacturing ultra low expansion glass according to another embodiment of the invention;

FIG. 5 is a schematic drawing of an apparatus for manufacturing ultra low expansion glass according to another embodiment of the invention; and

FIG. 6 is a schematic drawing of an apparatus for collecting silica-titania powder particles according to another embodiment of the invention.

FIG. 7 is a graph comparing the homogeneity of glass produced by the present invention compared to glass produced by the prior art.

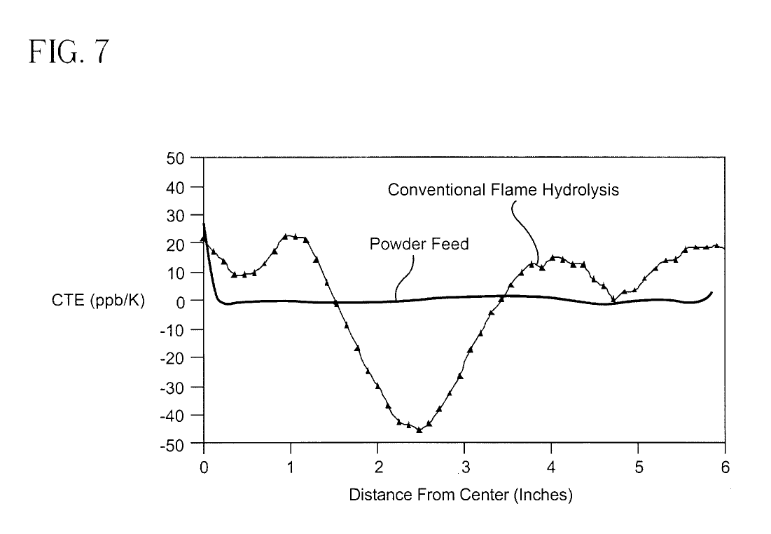

### DETAILED DESCRIPTION

The invention provides methods and apparatus for manufacturing glass bodies having low thermal expansion and homogeneous titania concentrations. The methods and apparatus are particularly useful for the manufacture of extreme ultraviolet optical elements such as lithography substrates for both lithography masks and lithography mirror optics. The methods and apparatus avoid striae problems encountered during the formation of boules in conventional direct deposit flame hydrolysis boule process, particularly when the glass is ground and polished into a curved mirror reflective surface that cuts across the planar striae levels.

The invention further pertains to making thermally stable EUV lithography structure objects such as optical mirror lithography element substrate structures and reflective lithography mask element substrate structures. PCT patent publication WO 01/08163, entitled EUV SOFT X-RAY PROJECTION LITHOGRAPHIC METHOD SYSTEM AND LITHOGRAPHY ELEMENTS commonly assigned to CORNING INCORPORATED and naming Davis et al. as inventors and WO 01/07967, entitled EUV SOFT X-RAY PROJECTION LITHOGRAPHIC METHOD AND MASK DEVICES commonly assigned to CORNING INCORPORATED and naming Davis et al. as inventors, the contents of which are hereby incorporated by reference discloses EUV lithography mirror element and mask structures.

According to the present invention, methods and apparatus are provided for the production ultra low expansion titania-silica glass elements. In overview, silica-titania powders are provided outside of a furnace, and the powders are delivered into a furnace cavity heated to temperatures sufficient to consolidate the into a glass boule. Typically, temperatures above 1600° C. are sufficient to consolidate the powder into a glass boule. In certain preferred embodiments, the feed rate of the powder is maintained at a rate to minimize trapping of gasses caused by overlapping powder layers. By depositing and consolidating successive layers of powder, the boule will grow over time. After a boule of the desired size is formed, the glass boule can be removed from the furnace for further processing. In some embodiments, additional processing may include steps such as hot isostatic pressing of the boule to reduce seeds in the glass.

In one embodiment, the titania-silica powder and glass contains between about 5 weight percent and 10 weight percent titania, and preferably the amount of titania is between about 6 weight percent and 10 weight percent. According to one preferred embodiment of the present invention, the titania silica powder and glass contains about 7 weight percent titania.

In certain preferred embodiments, powders, ultra low expansion titania-silica glass bodies and EUV optical elements are provided having a homogeneous titania level in the range from 6 wt. % TiO₂ to about 9 wt. % TiO₂ and a homogeneous CTE in the range of about +30 ppb/° C. to −30 ppb/° C. between about 20° C. and 25° C., preferably in the range of about +20 ppb/° C. to −20 ppb/° C. between about 20° C. and 25° C. More preferably, the powder, the glass and optical elements have a homogeneous titania silica glass titania level in the range from 6 wt. % TiO₂ to about 9 wt. % TiO₂ and a homogeneous CTE in the range of about +10 ppb/° C. to −10 ppb/° C. between about 20° and 25° C., and most preferably a CTE in the range of about +5 ppb/° C. to −5 ppb/° C. between about 20° C. and 25° C., with the CTE having a variation in coefficient of thermal expansion less than 5 ppb/° C. Preferably the powder particles and the titania-containing silica glass have a titania level in the range from 6 wt. % TiO₂ to 8 wt. % TiO₂. More preferably, the powder, the consolidated glass and the EUV optical substrate have a titania level in the range from 6 wt. % TiO₂ to 8 wt. % TiO₂. More preferably, the level of titania contained in the silica powder particles and the silica-titania glass is between about 6.8 and 7.5 wt. % TiO₂.

The stoichiometry of the boule made by the methods and apparatus of the present invention will primarily be determined by the stoichiometry of the starting powders. Titania and silica do not interdiffuse at an appreciable rate at forming temperatures less than 1800° C. Therefore, in preferred embodiments, a uniform titania distribution in the boule is achieved by starting with powders that are pre-mixed on an atomic scale by techniques including but not limited to flame hydrolysis and sol-gel processing. The starting powders could also consist of ground titania-silica glass cullet. Powders made by sol-gel processing can be used without additional processing. However, if the powders consist of extreme small particles that result in a fluffy, poorly flowing powder, additional processing steps further described below may be necessary to facilitate delivery and consolidation of the powders to a furnace.

Accordingly, in some embodiments, smaller particles are agglomerated into larger particle clusters. For example, spray drying techniques can be used to treat or agglomerate the powder prior to delivery of the powder into the furnace. Other agglomeration methods that can be used include the use of a pan pelletizer available from Feeco International, Green Bay, Wis. A pan pelletizer forms agglomerates by continuously feeding powdered material to a pan that is wetted by a water spray. The rotating action of the pan causes the moistened material to form small seed type particles. The seed particles then form larger agglomerates until they are discharged from the pan. In other embodiments, agglomeration of smaller particles can be accomplished by forming a slurry including water and between about 35% and 50% by weight solid powder. Drops of slurry having a volume between about 0.5 and 2 ml can be placed on a teflon coated plate and dried overnight.

In certain embodiments, it may be useful to preconsolidate the powder particles prior to delivery into the furnace. In the embodiments in which a preconsolidation step is utilized, the preconsolidation step is performed preferably at a temperature above 1300° C. In certain embodiments, the preconsolidation step is performed in a helium or vacuum atmosphere. In other embodiments, agglomerated powders may be impregnated with helium prior to preconsolidation. For example, agglomerated powder may be placed in a vacuum for 10 minutes, and then placed in a helium environment at about 1-10 psi positive pressure.

Additional powder processing to make poorly flowing powders more free-flowing may include spray drying the powders. Spray-drying the powders will agglomerate the smaller particles into larger clusters comprised of the smaller particles. The powders can also be agglomerated by freeze-drying the powders. Powders that have been agglomerated may be further processed by pre-consolidating the powders. Pre-consolidation involves heating powders up to temperatures exceeding about 1300° C., and experimentation has indicated that a presently preferred range is in the area of about 1400° C. to 1500° C. Experimentation has further indicated that pre-consolidation in a vacuum or helium environment improves powder characteristics. After pre-consolidation, it may be necessary to mechanically agitate the particles to facilitate flow of the powder. The mechanical agitation method selected should be a method that minimizes contamination, for example, the used of a teflon coated grinding system or milling such as ball milling with plastic media.

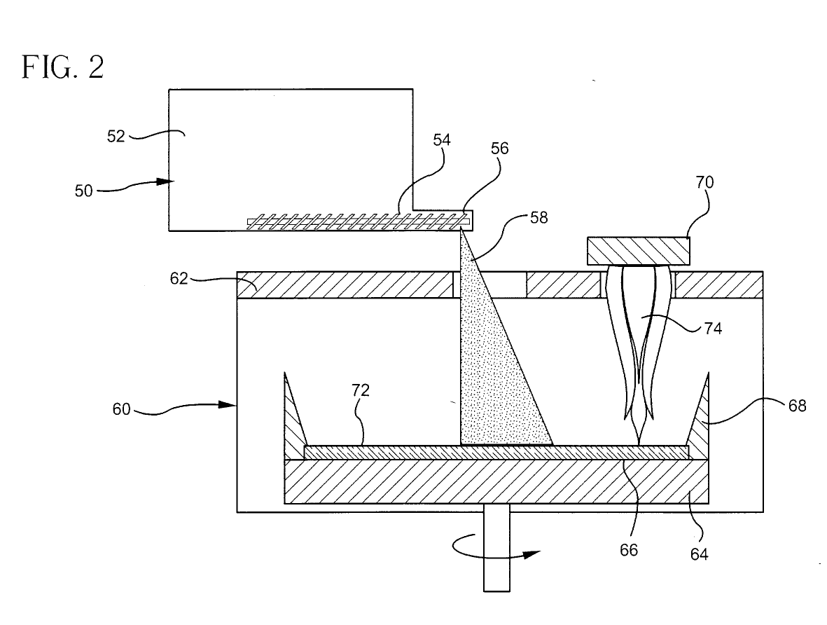

In preferred embodiments, the powders are pre-consolidated into agglomerates and delivered into the furnace at a fixed feed rate. Various types of feed systems can be used to deliver the powder to the furnace. Referring to FIG. 2, an example of a powder feed system 50 used according to one embodiment of the invention includes a container 52 such as a hopper for holding the powder and an auger 54, which feeds the powder through a tube 56 as the powder 58 exits the end of the tube 56 into furnace 60. In another adaptation, a vibratory gravity feed system can be used instead of an auger to reduce powder contamination that may occur from an auger feed system. The various embodiments of the invention are not limited to any particular furnace system or configuration. For the purposes of illustration, the furnace 60 in FIG. 2 includes a crown 62, which is made from an appropriate refractory material such as zircon. The furnace 60 may further include a cup 64 which includes a collection surface 66 and containment walls 68. The cup 64 may rotate as shown in FIG. 2, or the cup 64 may oscillate. Alternatively, the cup 64 may be stationary. Heat is provided to the furnace 60 by at least one burner 70. In operation, as the powder 58 is ejected out the end of tube 56, either gravity feeds the powder 58 onto the collection surface 66 of the cup 64 or gas currents direct the powder onto the collection surface. The burner 70 provides a flame 74 which generates heat and consolidates the powder into a boule 72.

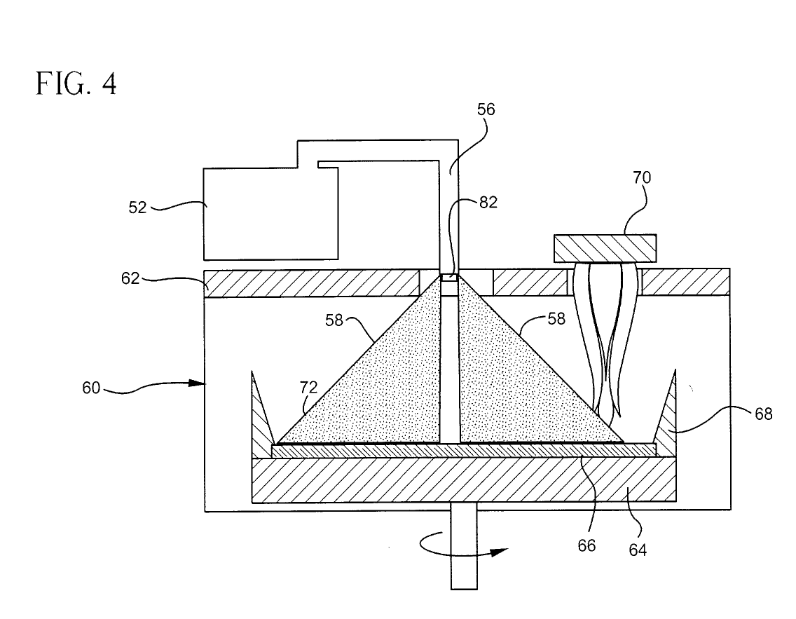

It will be appreciated that larger powder particles are well-suited for the gravity feed system shown in FIG. 2. However, smaller particles are more susceptible to air currents and electrostatic forces that will impede delivery of particles into the furnace. Smaller particles, typically less than about 100 microns, may require alternative transport mechanisms such as directed gas currents to deliver the particles to the furnace 60. An air handling system such as a blower 80 can be utilized to deliver the smaller powder particles into the furnace 60. Alternatively, the particles may be directed into the flame which then directs the powder towards the boule surface. In still another alternative embodiment shown in FIG. 4, the powder distribution system may further include a spray nozzle 82 or other suitable device to distribute or disperse the powder 58 across the collection surface 60 in the furnace 60.

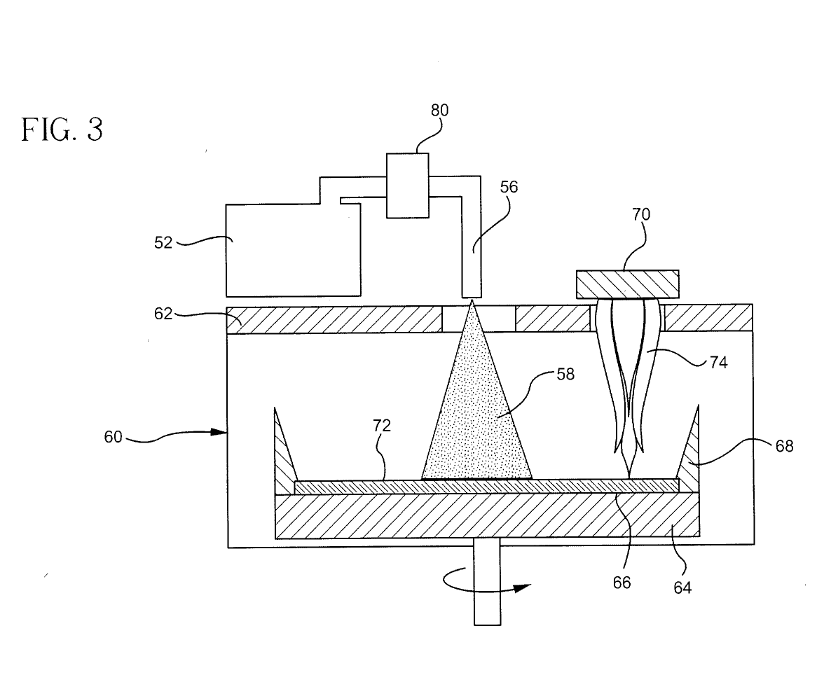

The powders may be fed into the furnace separated from the flame as shown in FIG. 2 and FIG. 3, or alternatively the powder can be fed into the flame as shown in FIG. 4. It may be advantageous to inject the powders into the flame to accelerate heat transfer from the flame to the powder. Pre-heating of the powder may promote and accelerate growth of the boule. Separation of the powder production system and the powder consolidation system in accordance with the present invention simplifies system design when compared with conventional boule production systems. Separation of the powder production system from the burner and flame minimizes the chances of volatilization of precursor materials, which may lead to inhomogeneities and non-uniformity in the powders.

Powders delivered into the furnace cavity can be heated and consolidated by a wide variety of heat sources, and examples of a several types of heat sources are described below. The invention is not limited to any particular type of heat source for heating the furnace cavity. In some embodiments of the invention, a burner flame as shown in FIGS. 2-4 can be utilized to heat the furnace cavity to consolidate the powder to a glass body. Such burners can provide a flame by igniting a fuel such as a mixture of methane and oxygen, or other appropriate fuels can be used. In other embodiments, alternative heat sources or combinations of heat sources can be utilized.

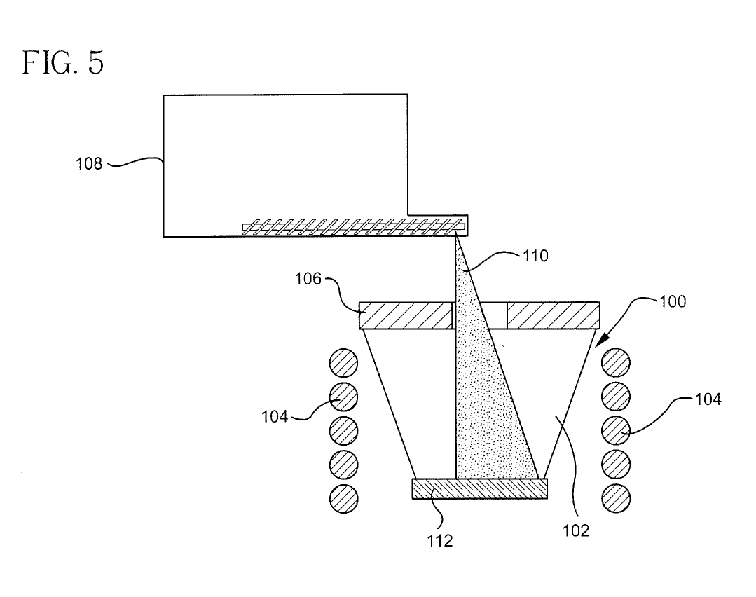

Referring to FIG. 5, in still other embodiments, a furnace 100, includes a particle container 102 made from a material such as platinum that acts as a susceptor for energy generated by coils 104. The container 102 is heated, and a crown or lid 106 retains heat generated by the container 102. Powder feed system 108 delivers powder particles 110 into the furnace 100, where the powder consolidates into a glass body 112. Ordinary resistance heaters can be used. Of course, other types of heating elements and systems can be utilized, as long as the heater used can provide heat sufficient to consolidate the powder particles into a glass body.

In certain embodiments, it may be desirable to make porous or semi-porous glass bodies. Such porous bodies can be made by using spray-dried powder particles that have not been pre-consolidated and feeding the particles into the furnace at a rate that causes pores to be trapped in the body of the glass. Alternatively, porous bodies can be produced by using hollow, spray dried powder particles. In addition, very rapid heating of the powder particles as they are being deposited into the furnace can be used to consolidate the surface of the particle, causing gases to be trapped in the interior of the particles. In certain embodiments, gaseous seeds trapped in the body of the glass can be eliminated by hot isostatically pressing the body of glass. By applying high temperatures in excess of 1200° C. and high pressure exceeding 50 pounds per square inch, gaseous seeds or bubbles in the glass can be collapsed and eliminated.

The present invention offers several advantages over conventional flame hydrolysis systems for manufacturing titania-silica low expansion glass bodies. According to the present invention, the powders can be mixed prior to delivery and consolidation in the furnace, enabling the manufacture of a glass body having a highly uniform and homogeneous composition. The stoichiometry of the final glass body should be virtually identical to the stoichiometry of the starting powders. Such a manufacturing process should create low expansion silica-titania glasses having reduced striae due to compositional gradients. In addition, the glass should be free from macroscopic compositional gradients and variations in coefficient of thermal expansion (CTE) throughout the body. With minimized variations, the glass body should have very low birefringence. The overall control of the CTE of the process is expected to be improved when compared with the conventional process.

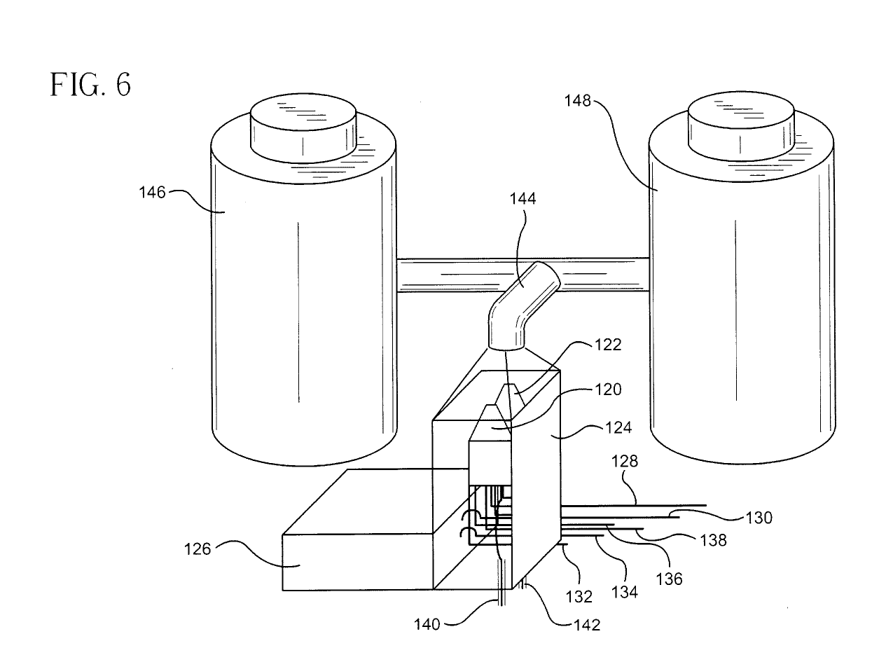

According to another embodiment of the invention, silica-titania powders can be manufactured and collected by using a particle generation and collection apparatus. Such a particle generation and collection apparatus is shown in FIG. 6. The apparatus includes burners 120 and 122 housed in an enclosure 124. Air supply to the burner enclosure 124 is pre-filtered with an appropriate filter 126 such as a HEPA filter. A burner flame is provided by supplying premixed burner gases from gas sources (not shown) via supply lines 128 and 130. Oxygen may be delivered to the burner via oxygen supply lines 132, 134, 136, and 138 which are connected to an oxygen source (not shown). Vaporous titanium and silicon containing precursor gases are delivered to the burners via delivery lines 140 and 142.

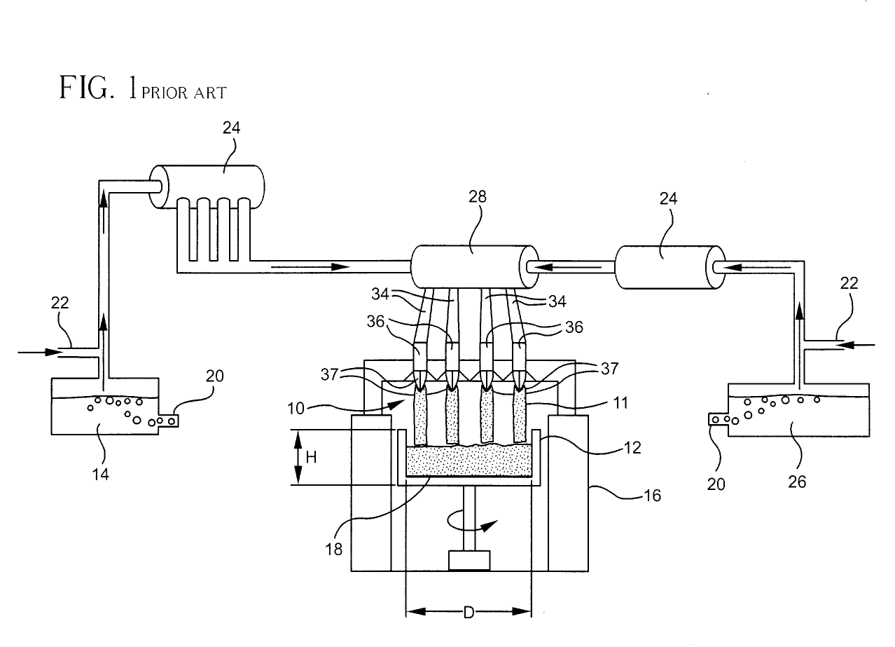

The feedstock or precursor materials for generating silica and titania particles can include siloxanes, alkoxides and tetrachlorides containing titanium or silicon. One preferred silicon-containing precursor material is octamethylcyclotetrasiloxane, and one preferred titanium-containing feedstock material is titanium isopropoxide. Other silicon-containing and titanium materials that can be used include silicon tetrachloride and titanium tetrachloride. The system for delivering the vaporous precursor containing gases shown in FIG. 1 can be used to generate particles via flame hydrolysis in burners 120 and 122. Therefore, an inert bubbler gas such as nitrogen is separately bubbled through silicon-containing and titanium-containing precursors to produce mixtures containing the feedstock vapors and carrier gas. An inert carrier gas such as nitrogen is combined with the silicon feedstock vapor and bubbler gas mixture and with the titanium feedstock vapor and bubbler gas mixture to prevent saturation and to deliver the precursor materials to the burners.

According to certain embodiments of the present invention, instead of delivering the particles directly into a furnace where the particles are consolidated into a glass body, the particles are delivered into conduit 140 and into collection devices 142 and 144, which may be, for example, baghouses.

Without intending to limit the invention in any manner, certain embodiments of the present invention will be more fully described by the following examples.

Powder Preparation

Three different samples of powders were produced. One set of powder consisted of ground cullet of titania-containing silica glass made by flame hydrolysis. This sample will be referred to as cullet. The second sample of powder consisted of soot collected in a flame hydrolysis apparatus of the type shown in FIG. 1 and collected prior to delivery into the furnace. The second sample of powder was also spray dried in a conventional spray drying apparatus by mixing a slurry containing between 30 and 70 weight percent soot and water mixed with ammonia. This sample will be referred to as the spray-dried powder. The third sample of powder was spray-dried soot that was pre-consolidated by spreading a layer of powder less than one-half inch thick onto a platinum foil and heating the powder to 1400° C. for 10 minutes and cooling the powder to room temperature. This sample will be referred to as the pre-consolidated powder.

### EXAMPLE 1

Three different powder samples were placed in three separate five inch diameter platinum crucibles at room temperature. The crucibles were heated in an apparatus similar to the type shown in FIG. 6 to a temperature of 1700° C. and held to this temperature in air. Thereafter, 25 gram samples of spray dried and pre-consolidated powder were added to the crucible at five minute intervals. The resulting glass contained pores and inclusions, but this example demonstrated the feasibility of manufacturing glass by a powder feed system

### EXAMPLE 2

A powder feed system similar to the system shown in FIG. 4 was used. A conventional flame hydrolysis burner was used to generate a flame using a mixture of methane and oxygen. The furnace was heated to a temperature of about 1700° C. with the collection surface rotating at about 3.7 RPM. The containment vessel was about 8 inches deep and about 6 inches in diameter. First, spray-dried powder was fed into the furnace through a hole having a diameter of about ½ inch through the furnace crown. An auger feed system was used to feed the powder into the furnace at a rate of between about 5 and 20 grams/minute. The spray-dried powder produced a porous glass, and feed rate did not appear to affect the microstructure of the glass body. The surface porosity of the body was about 50%

### EXAMPLE 3

The same type of apparatus and operating conditions were used as in Example 2, except in this example, pre-consolidated powders and a feed rate of 13 grams/minute were used. This process produced a finished glass body having a porosity of about 10%

### EXAMPLE 4

This example utilized an apparatus similar to the apparatus used in Examples 2 and 3. In an effort to reduce porosity in the finished bodies, a hotter crown temperature of about 1750° C. and a cup having a depth of about 10 inches and a diameter of 8 inches were employed. Pre-consolidated powders were pre-heated to 200° C. and fed into the furnace at two different feed rates. The diameter of the powder feed tube was increased to 2½ inches and the containment vessel RPM was increased to 20 RPM. A first run utilized a feed rate of 13 grams per minute, and this run produced a glass with low porosity and pore sizes of 150 microns and less. A second run at a feed rate of 9 grams/minute produced a glass having less porosity and pores less than 100 microns in size.

### EXAMPLE 5

A titania-containing silica powder was produced, and stoichiometry of the material was controlled by controlling the ratio of precursors mixed together. Table I identifies the results of five different powder production runs showing that the targeted stoichiometry was achieved, which resulted in homogenous CTE values of glass bodies produced using the powder feed process described below. The conditions of the powder runs included 1 slpm of methane mixed with 1 slpm oxygen as a fuel source to keep the precursors from extinguishing. Organic precursors mixed at an approximate ratio 1:4.5 of titanium tetraisoproproxide to OMCTS were injected into a vaporizer at 140° C. with 8 slpm nitrogen carrier which then were carried to two burners and combusted with 6 slpm oxygen and enough pre-filtered air to cool the overall temperature to about 100° C. The powder was then collected in the baghouses and used in the next processes.

TABLE I

| | WT % | WT % |
|---|---|---|
| Sample | Targeted | Achieved |
| 1 | 7.24 | 7.19 |
| 2 | 7.44 | 7.4 |
| 3 | 7.44 | 7.43 |
| 4 | 7.44 | 7.43 |
| 5 | 7.44 | 7.5 |

The formed powder was next mixed with DI water at a ratio of about 1:1 powder: water ratio to create a slurry which was then pumped onto a teflon coated tray to make powder “dots” or pellets. The water was then dried by placing in a drying oven at 40° C. If the temperature was increased to 60° C., the dots developed porous center as a result of the change in rheology of the slurry during drying. Therefore, 40° C. was used for the drying conditions for this particular powder/water mixture. The dots were dried and released easily from the teflon coated trays. Static guns were used to minimize static build up upon removal of the dried dots from the trays and into a platinum pan. The dots were loaded into a platinum tray and heated in flowing helium to 1400° C. to consolidate the dots.

The consolidated dots were then fed into the furnace cavity which was preheated to a crown temperature of 1700 C. (expected boule temperature of about 1850° C. to 1950° C.). A vibratory feeder was used which fed into a quartz tube and through a hole in the crown at a rate of approximately 5 g/min. The furnace was rotated at 20 rpm and heated with methane/oxygen flames. The resultant glass was checked for uniform titania concentration with an XRF tool across the radial scan. FIG. 6 show a graph of the CTE values achieved of boules produced in the range of about +10 ppb/° C. to −10 ppb/° C. between about 20° C. and 25° C., and as low as about +5 ppb/° C. to −5 ppb/° C. between about 20° C. and 25° C. The results showed a uniform distribution of titania. The composition of glass made by the conventional process in the same furnace is shown for comparison. As can be seen, a large improvement in CTE homogeneity is demonstrated.

It will be apparent to those skilled in the art that various modifications and variations can be made to the present invention without departing from the spirit or scope of the invention. Thus, it is intended that the present invention covers modifications and variations of this invention provided they come within the scope of the appended claims and their equivalents.

What is claimed is:

1. A method of making an extreme ultraviolet optical element comprising the steps of:
providing a furnace cavity heated to a temperature sufficient to consolidate titania-containing silica powder into a glass body;
providing titania-containing silica powder outside of the furnace cavity;
delivering the titania-containing silica powder to the interior of the furnace cavity;
consolidating the titania-containing silica powder into a glass body; and
finishing the glass body into an optical element.

2. The method of claim 1, wherein the titania concentration in the silica powder is between 3 weight percent and 10 weight percent.

3. The method of claim 1, wherein the furnace is heated to a temperature above 1600° C.

4. The method of claim 1, wherein the powder is delivered at a rate to prevent trapping of gases by overlapping powder layers.

5. The method of claim 4, wherein the powder particles are preconsolidated into groups of particles prior to delivery into the furnace, wherein the preconsolidation step is performed at a temperature above 1300° C. in a helium or vacuum atmosphere.

6. The method of claim 1, further including the step of hot isostatically pressing the body at a temperature exceeding 1200° C. and a pressure exceeding 50 pounds per square inch.

7. The method of claim 1, wherein the extreme ultraviolet optical element has a homogeneous titania level in the range from 6 wt. % to 9 wt. % and a homogeneous CTE in the range of about +30 ppb/° C. to −30 ppb/° C. between 20° C. and 25° C.

8. A method of manufacturing a reflective extreme ultraviolet lithographic element comprising the steps of:
providing a furnace cavity heated to a temperature sufficient to consolidate titania-containing silica powder into a glass body;
providing titania-containing silica powder outside of the furnace cavity the powder having a titania level in the range from 6 wt. % to 9 wt. %;
delivering the titania-containing silica powder to the interior of the furnace cavity;
consolidating the titania-containing silica powder into a glass body wherein the body has a homogeneous titania-silica glass titania level in the range from 6 wt. % to about 9 wt. % and a homogeneous CTE in the range of about +30 ppb/° C. to −30 ppb/° C. between about 20° C. and 25° C.; and
finishing the glass body into a reflective extreme ultraviolet optical element.

9. The method of claim 8, further comprising the step of pre-consolidating the powder particles in a helium or vacuum environment prior to delivery into the furnace at a temperature above 1300° C.

10. The method of claim 9, wherein the glass body has a homogeneous CTE in the range of about +20 ppb/° C. to −20 ppb/° C. between about 20° C. and 25° C.

11. An apparatus for manufacturing a body of high purity fused silica glass containing titania comprising:
a furnace including a cavity heated to a temperature sufficient to consolidate titania-containing silica powder into a glass body;
a supply of titania-containing silica powder located outside of the furnace cavity; and
a delivery system for transporting the titania-containing silica powder to the interior of the furnace cavity.

12. The method of claim 11, wherein the glass body has a homogeneous CTE in the range of about +5 ppb/° C. to −5 ppb/° C. between about 20° C. and 25° C.
